(19) United States
(12) Patent Application Publication
(10) Pub. No.: US 2007/0122231 A1
(43) Pub. Date: May 31, 2007

(54) TUBE WITH FINGER-LIKE APPLICATOR, HOLDING RING AND SLIDABLE SQUEEZE BAND

(76) Inventor: D'Juan Armstrong, Jacksonville, FL (US)

Correspondence Address: MARK YOUNG, P.A., 12086 FORT CAROLINE ROAD, UNIT 202, JACKSONVILLE, FL, 32225, US

(21) Appl. No.: 11/563,521

(22) Filed: Nov. 27, 2006

Related U.S. Application Data
(60) Provisional application No. 60/597,342, filed on Nov. 26, 2005.

(51) Int. Cl. B43K 1/06; B43M 11/06

(52) U.S. Cl. 401/265; 401/183

(57) ABSTRACT

An improved tube for dispensing viscous fluids includes a finger-like applicator, a holder and an occlusion belt. The applicator may be a locking applicator selectively adjustable to an opened or closed position. The holder enables hanging the tube from an elongated structure such as a finger. The occlusion belt prevents contents from being forced back down to the bottom of the tube.

### RELATED APPLICATION

This application claims the benefit of priority of U.S. Provisional Application 60/597,342, filed Nov. 26, 2005, the entire contents of which are incorporated herein.

### FIELD OF THE INVENTION

This invention generally relates to tubes, and more particularly, to improvements for tubes for dispensing viscous paste, grease or gel-like substances.

### BACKGROUND

Collapsible squeeze tubes are used to store and dispense many viscous fluids, such as pastes, greases and gel-like products. Typically, such tubes are formed of a plastic and/or foil material with a sealed crimp/fold at one end and a cap or other suitable closure means at the opposite end. Such tubes can be formed of many suitable materials of varying degrees of pliability, with many different sizes, and adapted to store and dispense many different substances.

Illustratively, such tubes are used to dispense hair care products. Human hair varies widely in its structure and texture. Since hair takes time to produce natural oils, many people apply products to provide nutrients that are otherwise washed away during shampooing. Many such products also enable hair styling. By way of example, hair products called “hair grease” are leave-in conditioners that supply the hair with oils and other needed supplements to make hair healthy and shiny.

Typically, hair grease is scooped from a container or squeezed from a tube and then rubbed into the hair and/or scalp using one or more fingers. This approach is inconvenient as it requires retrieving the container or tube, typically from a nearby shelf, each time an amount of grease is applied. Another problem is that this approach requires the user to handle the grease. These problems are particularly acute for a professional hair stylist who may apply copious amounts of grease throughout a workday.

An improved tube for hair grease and other similar substances is needed. Preferably, such a tube includes an applicator that can be used instead of a finger. Additionally, such a tube preferably includes a holder to enable holding the tube while performing a task. Furthermore, such a tube preferably includes a band to squeeze the tube from bottom to top in an orderly manner.

The invention is directed to overcoming one or more of the problems and solving one or more of the needs as set forth above.

### SUMMARY OF THE INVENTION

To solve one or more of the problems set forth above, in an exemplary implementation of the invention, provides improvements for tubes for dispensing viscous fluids. The improvements include a finger-like applicator, a holder and an occlusion belt. The applicator may be a locking applicator selectively adjustable to an opened or closed position. The holder enables hanging the tube from an elongated structure such as a finger. The occlusion belt prevents contents from being forced back down to the bottom of the tube.

Thus, in one aspect of the invention, an improved pliable tube for dispensing viscous contents with a finger-like applicator is provided. The pliable tube has a threaded neck and a finger-like applicator adapted for use on the pliable tube. The applicator includes a first end threadedly adapted to engage the threaded neck of the pliable tube and a second end opposite to the first end. The second end is blunt and shaped like a fingertip. A channel extends from the first end to the second end. The channel is adapted for directing the viscous contents. The applicator comprises a resilient, rigid or pliant material.

Optionally, an applicator base is disposed between the first end of the finger-like applicator and the pliable tube. The base may be rotatably attachable to the first end of the applicator and adapted to selectively move relative to the finger-like applicator into an open configuration or a closed configuration.

In another aspect of the invention, an improved pliable tube for dispensing viscous contents with a holder is provided. The holder may be comprised of a ring or band attached to the tube, such as at or near the sealed end of the tube.

In another aspect of the invention, an improved pliable tube for dispensing viscous contents with a belt is provided. The belt is a band configured to encircle and closely fit a section of the pliable tube as it is flattened to dispense viscous contents. The belt forms an occlusion at the encircled section of the tube. The belt may be resilient or rigid.

### BRIEF DESCRIPTION OF THE DRAWINGS

The foregoing and other aspects, objects, features and advantages of the invention will become better understood with reference to the following description, appended claims, and accompanying drawings, where:

FIG. 1 conceptually illustrates an exemplary tube in use according to principles of the invention; and

FIG. 1A conceptually illustrates an exemplary a finger-like applicator for a tube according to principles of the invention; and

FIG. 1B conceptually illustrates an exemplary holding ring for a tube according to principles of the invention; and

FIG. 2 conceptually illustrates an exemplary tube with a squeeze belt according to principles of the invention.

Those skilled in the art will appreciate that the figures are not intended to be drawn to any particular scale; the invention is not limited to the dimensions, configurations or proportions shown in the figures; and the figures are non-limiting examples, which are not intended to illustrate every embodiment of the invention. The invention is not limited to the exemplary embodiments depicted in the figures or the shapes, relative sizes, ornamental aspects, dimensions, proportions, or uses shown in the figures.

### DETAILED DESCRIPTION

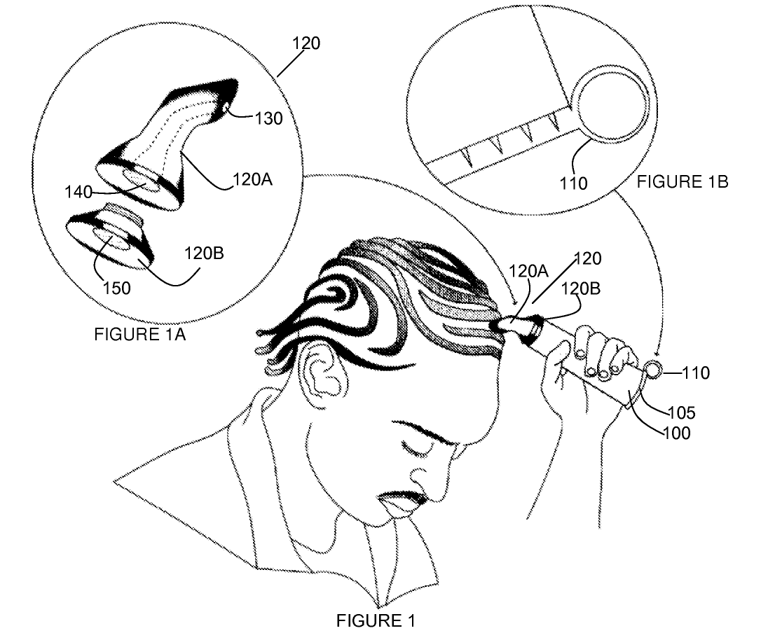

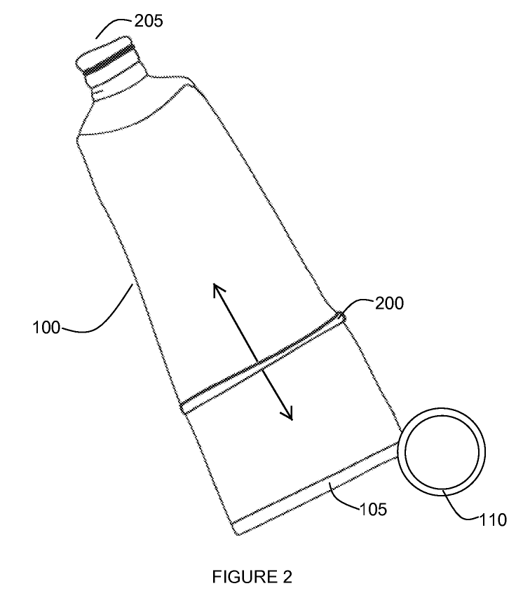

In an exemplary implementation, referring to FIG. 1, a collapsible tube 100 according to the principles of the invention is preferably formed of a pliable (e.g., plastic and/or foil) material in a tube configuration, sealed (e.g., crimped) 105 at one end and opened 205 (as shown in FIG. 2) at the opposite end. In an exemplary embodiment, the opening includes a threaded neck 205. A suitable closure is also provided for sealing the tube. The body of the tube 100 defines an interior compartment for containing a viscous material, such as a gel-like or grease-like substance. These features are typical for collapsible tubes, and tube 100 is intended to represent any collapsible tube suitable for dispensing a viscous material. As would be apparent to those of ordinary skill in the art, the tube 100 can be formed of many suitable materials of varying degrees of pliability, and the invention is not limited to a tube comprised of plastic or foil.

Advantageously, the invention provides a finger-like applicator 120 for use on a tube according to the principles of the invention, as well as on any conventional collapsible tube. The finger-like applicator 120 includes a blunt free end with a surface comparable in shape and size to a rubbing surface of a fingertip. The exemplary finger-like applicator 120 includes a bent finger-shaped structure 120A with a channel 140 extending from a tube end to an opening 130 at the opposite blunt free end. The finger-like applicator 120 may be bent or straight. The finger-like applicator may be used to dispense a paste, grease or gel-like product, or other viscous fluid, directly on a surface without using one's finger. Thus, for example, as shown in FIG. 1, the applicator 120 may be used to apply grease directly to a person's hair or scalp. The applicator may have a threaded tube end that is configured to mate directly with a threaded neck 205 of a tube.

Alternatively, an applicator base 120B may be disposed between the finger-like applicator 120A and the tube 100. The base may have a threaded tube end that is configured to mate directly with a threaded neck 205 of a tube. The opposite end of the base 120B may be configured to engage (e.g., threadedly engage) the finger-like applicator 120A. The base 120B may include one or more apertures defining a passage from the tube interior through the base 120B. These one or more apertures apertures may be adapted to selectively align with the channel 140 of the finger-like applicator 120A when the finger-like applicator 120A is turned to an open position, but not align when the finger-like applicator 120A is turned to a closed position. In the closed position, the misalignment prevents product from escaping the tube through the applicator 120. One or more stops (not shown) may physically limit rotation of the finger-like applicator 120A from an open position to a closed position. Other opening and closing configurations and arrangements (e.g., push-pull arrangements) as known in the art may be applied to the applicator 120 without departing from the invention.

The applicator 120 may be comprised of any material suitable for the particular application. By way of example and not limitation, the applicator 120 may be comprised of polyvinyl chloride (PVC), polyethylene, polypropylene, polystyrene, acrylics, cellulosics, acrylonitrile-butadiene-styrene terpolymers, urethanes, thermo-plastic resins, thermo-plastic elastomers (TPE), acetal resins, polyamides, silicones, polycarbonates and/or polyesters. While many other materials may be used alone or in combination with the aforementioned materials and/or other materials, without departing from the scope of the present invention, preferably the material is relatively inexpensive and durable, easy to use in manufacturing operations and results in an aesthetically acceptable, washable, water resistant product that is compatible with the dispensed viscous material. The material comprising the applicator may further include additives to provide desired properties such as desired colors, structural characteristics (e.g., matrix or fiber reinforcements), phosphorescent (i.e., glow-in-the dark) properties and thermal reactivity (e.g., color changes according to heat). The applicator may also be rigid, pliant or resilient.

As yet another advantage, an exemplary collapsible tube according to principles of the invention may include a holder. An exemplary holder is comprised of a ring 110 attached to the tube. The holder allows a user to suspend the tube from a finger, hook or other suitable elongated structure. Thus, for example, a user may use the ring 110 to suspend the tube form a pinky finger, while performing a task. Then, when the tube is needed, it is already in hand. Additionally, a retailer may use the ring 110 to suspend the tube from a hangar during display. Likewise, a user may use the ring 110 to suspend the tube from a hangar during storage. Although the ring 110 is shown as a circular structure attached to the sealed end of the tube, other shapes and other attachment locations may be used without departing from the scope of the invention. The ring 110 may be integrally formed as part of the tube 100 or a separate component attached to the tube 100 during the manufacturing process.

The ring 110 may be comprised of any material suitable for the particular application. By way of example and not limitation, the ring 120 may be comprised of the same material as the tube, or polyvinyl chloride (PVC), polyethylene, polypropylene, polystyrene, acrylics, cellulosics, acrylonitrile-butadiene-styrene terpolymers, urethanes, thermo-plastic resins, thermo-plastic elastomers (TPE), acetal resins, polyamides, silicones, polycarbonates and/or polyesters. While many other materials may be used alone or in combination with the aforementioned materials and/or other materials, without departing from the scope of the present invention, preferably the material is relatively inexpensive and durable, easy to use in manufacturing operations and results in an aesthetically acceptable, washable, water resistant product. The material may further include additives to provide desired properties such as desired colors, structural characteristics (e.g., matrix or fiber reinforcements), phosphorescent (i.e., glow-in-the dark) properties and thermal reactivity (e.g., color changes according to heat). The ring 110 may also be rigid or flexible.

As yet another advantage, an exemplary collapsible tube according to principles of the invention may include a squeeze belt 200. Due to the viscous nature of products contained in the tube, it is often difficult to expel the product completely from the lower reaches of the tube. Localized squeezing of the tube, often forces some of the viscous product to the bottom of the tube and results in some product remaining in the tube. The slidable belt 200 mitigates this problem by helping to force all of the tube contents toward the open end of the tube and creating an occlusion to prevent contents from flowing past the belt 200 towards the closed end of the tube. The belt 200 encircles and closely fits the tube as flattened. The belt 200 forms a slot that is extremely narrow such that all of the contents are forced from the tube as the device is advanced and the device relies on the interference fit created by the close fitting slot to prevent the material from regressing through the slot into the collapsed portion of the tube.

While the invention has been described in terms of various embodiments, implementations and examples, those skilled in the art will recognize that the invention can be practiced with modification within the spirit and scope of the appended claims including equivalents thereof. The foregoing is not intended to limit the invention to the exact construction and operation shown and described. Alternative embodiments of the invention, including variations in size, materials, components, shape, form, function, manner of operation, assembly and use that are obvious to one skilled in the art are intended to be encompassed by the invention. Accordingly, all suitable modifications and equivalents may be resorted to, falling within the scope of the invention.

What is claimed is:

1. A pliable tube for dispensing viscous contents, said pliable tube having a threaded neck and a finger-like applicator adapted for use on the pliable tube having a threaded neck,
said applicator including a first end threadedly adapted to engage the threaded neck of the pliable tube, a second end opposite to the first end, said second end being blunt and shaped like a fingertip, and a channel extending from the first end to the second end, said channel being adapted for directing said viscous contents.

2. A pliable tube for dispensing viscous contents having a finger-like applicator according to claim 1, said applicator comprising a resilient material.

3. A pliable tube for dispensing viscous contents having a finger-like applicator according to claim 1, said applicator comprising a pliable material.

4. A pliable tube for dispensing viscous contents having a finger-like applicator according to claim 1, said applicator comprising a rigid material.

5. A pliable tube for dispensing viscous contents having a finger-like applicator according to claim 1, said finger-like applicator further comprising an applicator base, said applicator base being adapted to be disposed between said first end of the finger-like applicator and said pliable tube, said base being rotatably attachable to said first end of the applicator, and said base further being adapted to selectively move relative to the finger-like applicator into an open configuration or a closed configuration.

6. A pliable tube for dispensing viscous contents having a finger-like applicator according to claim 1, said pliable tube having a sealed end and an opposite open end, said pliable tube further comprising a holder.

7. A pliable tube for dispensing viscous contents having a finger-like applicator according to claim 1, said pliable tube having a sealed end and an opposite open end, said pliable tube further comprising a holder, wherein the holder is comprised of a ring attached to the tube.

8. A pliable tube for dispensing viscous contents having a finger-like applicator according to claim 1, said pliable tube having a sealed end and an opposite open end, said pliable tube further comprising a holder, wherein the holder is comprised of a band attached to the tube.

9. A pliable tube for dispensing viscous contents having a finger-like applicator according to claim 1, said pliable tube having a sealed end and an opposite open end, said pliable tube further comprising a holder, wherein the holder is comprised of a ring attached to the sealed end of the tube.

10. A pliable tube for dispensing viscous contents having a finger-like applicator according to claim 1, said pliable tube having a sealed end and an opposite open end, said pliable tube further including a belt, said belt comprising a band configured to encircle and closely fit a section of the pliable tube as flattened and to form an occlusion at the encircled section of the tube.

11. A pliable tube for dispensing viscous contents having a finger-like applicator according to claim 1, said pliable tube having a sealed end and an opposite open end, said pliable tube further including an adjustable belt, said belt being slidingly disposed on the tube and comprising a resilient band configured to surround and occlude a section of the pliable tube.

12. A pliable tube for dispensing viscous contents having a finger-like applicator according to claim 1, said pliable tube having a sealed end and an opposite open end, said pliable tube further including an adjustable belt, said belt being slidingly disposed on the tube and comprising a rigid band configured to surround and occlude a section of the pliable tube.

13. A pliable tube for dispensing viscous contents, said pliable tube having a threaded neck and a finger-like applicator adapted for use on the pliable tube having a threaded neck,
said applicator including a first end threadedly adapted to engage the threaded neck of the pliable tube, a second end opposite to the first end, said second end being blunt and shaped like a fingertip, and a channel extending from the first end to the second end, said channel being adapted for directing said viscous contents; and
said applicator comprising a material from the group consisting of a resilient material, a pliable material and a rigid material.

14. A pliable tube for dispensing viscous contents having a finger-like applicator according to claim 13, said finger-like applicator further comprising an applicator base, said applicator base being adapted to be disposed between said first end of the finger-like applicator and said pliable tube, said base being rotatably attachable to said first end of the applicator, and said base further being adapted to selectively move relative to the finger-like applicator into an open configuration or a closed configuration.

15. A pliable tube for dispensing viscous contents having a finger-like applicator according to claim 14, said pliable tube having a sealed end and an opposite open end, said pliable tube further comprising a holder.

16. A pliable tube for dispensing viscous contents having a finger-like applicator according to claim 15, wherein the holder is comprised of a device from the group consisting of a ring and band, said device being attached to the tube.

17. A pliable tube for dispensing viscous contents having a finger-like applicator according to claim 16, wherein the holder is attached to the sealed end of the tube.

18. A pliable tube for dispensing viscous contents having a finger-like applicator according to claim 17, said pliable tube further including a belt, said belt comprising a band configured to encircle and closely fit a section of the pliable tube as flattened and to form an occlusion at the encircled section of the tube.

19. A pliable tube for dispensing viscous contents having a finger-like applicator according to claim 18, said belt being an adjustable belt slidingly disposed on the tube.

20. A pliable tube for dispensing viscous contents having a finger-like applicator according to claim 19, said belt comprising a material from the group consisting of a rigid material and a resilient material.
